(19) United States
(12) Patent Application Publication
(10) Pub. No.: US 2008/0265035 A1
(43) Pub. Date: Oct. 30, 2008

(54) DUAL IMAGING LENS SYSTEM FOR BAR CODE READER

(75) Inventors: Igor Vinogradov, New York, NY (US); Edward D. Barkan, Miller Place, NY (US); Mark Drzymala, Commack, NY (US); Ming Yu, South Setauket, NY (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: Symbol Technologies, Inc., Holtsville, NY (US)

(21) Appl. No.: 11/739,888

(22) Filed: Apr. 25, 2007

(51) Int. Cl. G06K 7/10

(52) U.S. Cl. 235/462.41

(57) ABSTRACT

An imaging system for an imaging-based bar code reader for capturing an image of a target bar code. In one exemplary embodiment, the imaging system includes: a sensor array including an array of photosensitive elements for converting, light impinging on the array of photosensitive elements into electrical signals based on light intensity; an imaging lens system for focusing light from a field of view onto the sensor array, the imaging lens system including a first lens assembly and a second lens assembly, the first lens assembly defining a first field of view and the second lens assembly defining a second field of view, the first and second fields of view being different; and a control for selectively choosing between the first and second fields of view for imaging the target bar code.

### FIELD OF THE INVENTION

The present invention relates to an imaging lens system for an imaging-based bar code reader and, more particularly, to dual imaging lens system for an imaging-based bar code reader providing for differing fields of view and focal lengths.

### BACKGROUND ART

Various electro-optical systems have been developed for reading optical indicia, such as bar codes. A bar code is a coded, pattern of graphical indicia comprised of a series of bars and spaces of varying widths, the bars and spaces having differing light reflecting characteristics. Some of the more popular bar code symbologies include: Uniform Product Code (UPC), typically used in retail stores sales; Code 39, primarily used in inventory tracking; and Postnet, which is used for encoding zip codes for U.S. mail. Systems that read and decode bar codes employing charged coupled device (CCD) or complementary metal oxide semiconductor (CMOS) based imaging systems are typically referred to hereinafter as imaging systems, imaging-based bar code readers or bar code readers.

Bar code readers electro-optically transform the graphic indicia of the bar code into electrical signals, which are decoded into alphanumerical characters that are intended to be descriptive of the article containing the bar code. The characters are then typically represented in digital form and utilized as an input to a data processing system for various end-user applications such as point-of-sale processing, inventory control and the like.

Imaging systems used in bar code readers include charge coupled device (CCD) arrays, complementary metal oxide semiconductor (CMOS) arrays, or other imaging pixel arrays having a plurality of photosensitive elements (photosensors) or pixels, herein generally referred to as a sensor array.

An imaging lens assembly or system receives light from a field of view (FOV) of the imaging system and focuses the light, onto the sensor array. An illumination system comprising light emitting diodes (LEDs) or other light source directs illumination toward a target object, e.g., a target bar code. If a target bar code is within the field of view (FOV), the imaging lens assembly focuses an image of the target bar code onto the sensor array.

Periodically, the pixels of the sensor array are sequentially read out generating an analog signal representative of a captured image frame. The analog signal is amplified by a gain factor and the amplified analog signal is digitized by an analog-to-digital converter. Decoding circuitry of the imaging system processes the digitized signals representative of the captured image frame and attempts to decode the imaged barcode.

There are typically two types of imaging lens assemblies: 1) fixed focus systems; and 2) variable or zoom focus systems. In a fixed focus system, the field of view (FOV) and the working range of the imaging system is fixed. The working range of an imaging system is a distance range in front of or forward of the imaging lens assembly within which an object of interest, such as a target bar code, may be successfully imaged and decoded by the imaging system decoding circuitry. The working range is a function of, among other things, a focal distance of the imaging lens assembly.

The working range and field of view (FOV) require a user to move the bar code reader relative to the target bar code such that the target bar code is within the field of view (FOV) and within the working range of the imaging system for successful decoding of the imaged target bar code. For example, if the target bar code is positioned at a distance that is greater than the working range, the size of the imaged target bar code will be too small to successfully decode. That is, the pixels per module (PPM) will be too small to permit successful decoding. PPM is a measure of how many active pixels of a sensor array the smallest feature (bar or stripe) of a target bar code is imaged onto.

To permit variation in the field of view (FOV) and/or the working range of the imaging system, variable focus/zoom lens systems have been employed in imaging system of bar code readers. An imaging system that includes a zoom and variable focusing feature can greatly expand the working zone, that is, the field of view (FOV) and the working range, of the imaging system. In general, performance of an imaging-based bar code reader is limited by the PPM at a far focusing distance of the reader. For a given sized sensor array, the higher the density of a bar code, the lower the PPM and as PPM decreases the capability of the imaging system to obtain an image that permits complete decoding of the bar code also decreases. Variable focus/zoom lens systems can improve the PPM of the imaging system by providing a variable focal length system.

Known variable focus/zoom lens systems depend on either; 1) mechanical movement of one or more lenses of the lens assembly; or 2) the use of a liquid lens. A liquid lens is lens formed, by two immiscible liquids of differing conductivity sandwiched between two windows. As an electrical field applied to the liquids is varied, the shape of the interface between the liquids changes and thereby changes the optical properties of the liquid lens. However, both approaches to variable lens systems are complex and involve reliability and controllability issues.

What is needed is an imaging lens system that allows for changing a field of view (FV) and focal distance without the complexity and reliability issues inherent in variable focusing/zoom lens systems.

### SUMMARY

In one aspect, the present invention features an imaging system for an imaging-based bar code reader for capturing an image of a target bar code. In one exemplary embodiment, the imaging system includes: a sensor array including an array of photosensitive elements for converting light impinging on the array of photosensitive elements into electrical signals based on light intensity; an imaging lens system for focusing light from a field of view onto the sensor array, the imaging lens system including a first lens assembly and a second lens assembly, the first lens assembly defining a first field of view and the second lens assembly defining a second field of view, the first and second fields of view being different; and a control for selectively choosing between the first and second fields of view for imaging the target bar code.

In another aspect, the present invention features a bar code reader for imaging and decoding a target bar code. In one exemplary embodiment, the reader includes: a reader housing including a housing interior; an illumination assembly supported by the housing for emitting light to illuminate the target bar code; an imaging system within said housing interior for capturing an image of the target bar code; and decoding circuitry for decoding an image of the target bar code.

In one exemplary embodiment, the imaging system includes: a sensor array including an array of photosensitive elements for converting light impinging on the array of photosensitive elements into electrical signals based on light intensity; an imaging lens system for focusing light from the field of view onto the sensor array, the imaging lens system including a first lens assembly and a second lens assembly, the first lens assembly defining a first field of view and the second lens assembly defining a second field of view, the first and second fields of view being different; and a control for selectively choosing between the first and second fields of view for imaging the target bar code.

These and other objects, advantages, and features of the exemplary embodiments are described in detail in conjunction with the accompanying drawings.

### BRIEF DESCRIPTION OF THE DRAWINGS

FIG. 1 is a schematic side elevation view of an exemplary embodiment of an imaging-based bar code reader of the present invention;

FIG. 2 is a schematic front elevation view of the bar code reader of FIG. 1;

FIG. 3A and 3B are alternate representative schematics of an imaging focusing system of the present invention; and

FIG. 4 is a schematic block diagram of an imaging assembly of the bar code reader of FIG. 1.

### DETAILED DESCRIPTION

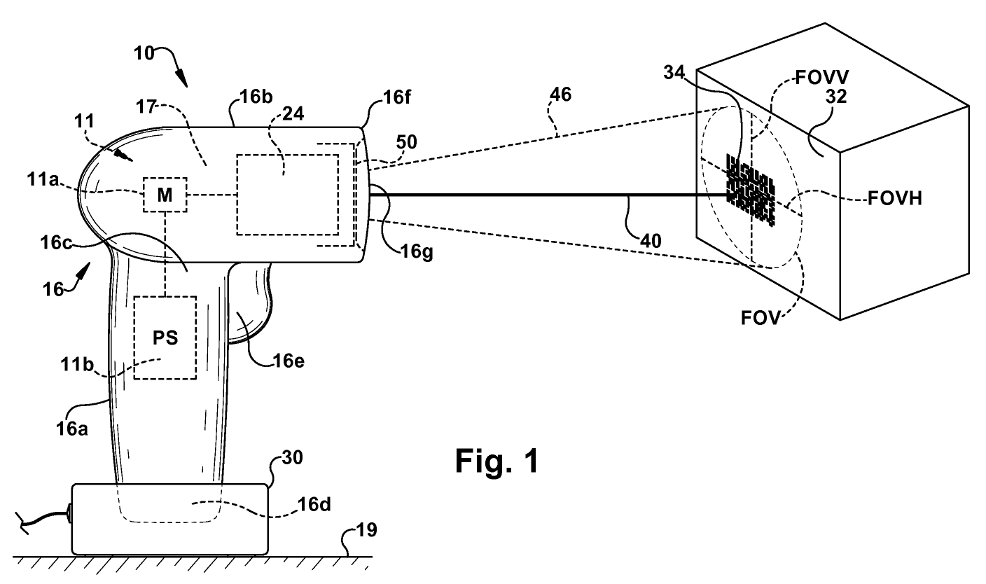

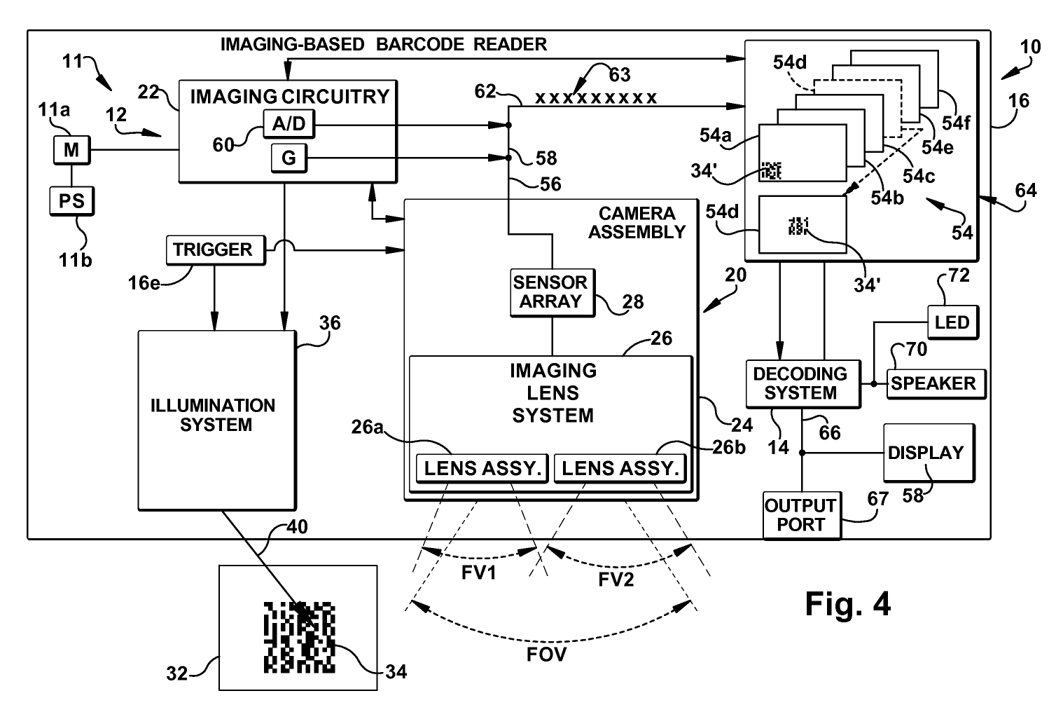

An exemplary embodiment of an imaging-based bar code reader of the present invention is shown schematically at 10 in the FIGS. 1 and 4. In one embodiment, the bar code reader 10 includes a two dimensional (2D) imaging system 12 and a decoding system 14 supported in a housing 16. The imaging and decoding systems 12, 14 are capable of reading, that is, imaging and decoding both 1D and 2D bar codes and postal codes. The reader 10 is also capable of capturing images and signatures. The imaging lens system of the present invention is equally applicable to bar code readers having a linear or one dimensional (1D) sensor array that is capable of imaging a 1D target bar code.

The decoding system 14 is adapted to decode encoded indicia within a selected captured image frame. The housing 16 supports reader circuitry 11 within an interior region 17 of the housing 16. The reader circuitry 11 includes a microprocessor 11a and a power supply 11b. The power supply 11b is electrically coupled to and provides power to the circuitry 11. The housing 16 also supports the imaging and decoding systems 12, 14 within the housing's interior region 17. The depicted reader 10 includes a docking station 30 adapted to receive the housing 16. The docking station 30 and the housing 16 support an electrical interface to allow electric coupling between circuitry resident in the housing 16 and circuitry resident in the docking station 30.

The imaging and decoding systems 12, 14 operate under the control of the microprocessor 11a. The imaging and decoding systems 12, 14 may be separate assemblies which are electrically coupled or may be integrated into a single imaging and decoding system. When removed from the docking station 30 of the reader 10, power is supplied to the imaging and decoding systems 12, 14 by the power supply 11b. The circuitry of the imaging and decoding systems 12, 14 may be embodied in hardware, software, firmware or electrical circuitry or any combination thereof. Moreover, portions of the circuitry 11 may be resident in the housing 16 or the docking station 30. It should also be recognized that the reader 10 may be connected to an external power supply by an electrical cord (not shown) as opposed to having an internal power supply 11b.

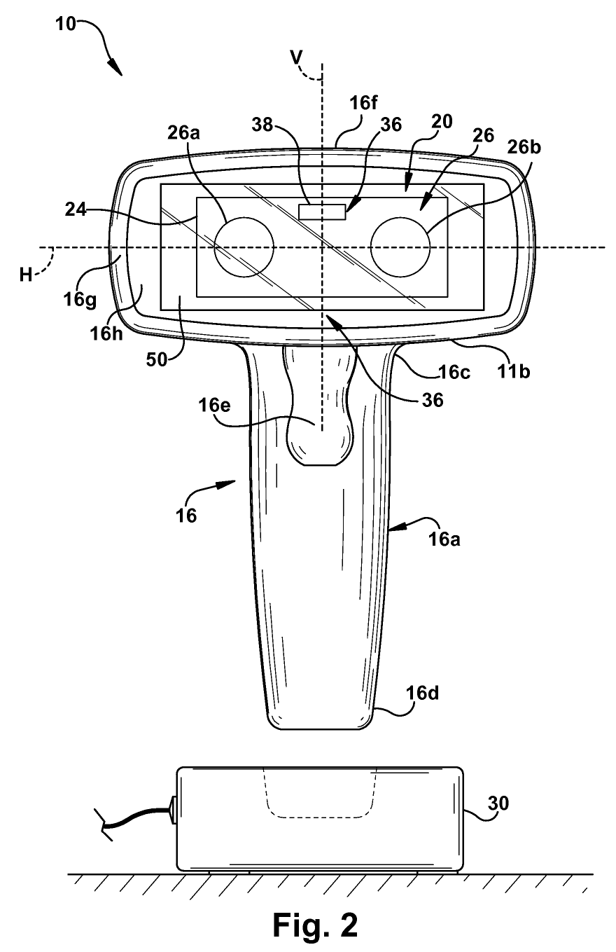

Advantageously, the bar code reader 10 of the present invention is adapted to be used in two modes of operation. In a hand-held or point-and-shoot mode of operation (FIG. 2), the reader 10 is carried and operated by a user walking or riding through a store, warehouse or plant for reading target bar codes for stocking and inventory control purposes. In the hand-held mode, the housing 16 is removed from a docking station 30 so the reader 10 can be carried by the user. The user grasps the housing gripping portion 16a and positions the housing 16 with respect to the target bar code 34 such that the target bar code is within an angular field of view (shown as FOV in FIG. 1) of the imaging system 12. It should be noted that the field of view FOV has both horizontal and vertical components shown schematically as FOVH (horizontal field of view) and FOVV (vertical field of view) in FIG. 1.

In the hand-held mode, imaging and decoding of the target bar code 34 is instituted by the user depressing a trigger switch 16e which extends through an opening near the upper part 16c of the gripping portion 16a. When the trigger 16e is depressed, the imaging system 12 generates a series of image frames (54a-54f for example) until either the user releases the trigger 16e, the image 34′ of one frame (54d for example) the target bar code 34 has been successfully decoded or a predetermined period of time elapses, whereupon the imaging system 12 awaits a new trigger signal.

In a fixed position or hands-free mode (FIG. 1), the reader 10 is received in the docking station 30 which is positioned on a substrate, such as a table or counter 19. The docking station 30 includes a generally planar lower surface to provide stability to the reader 10 when positioned on the substrate 19. In the fixed position mode, an object or item 32 with a target bar code 34 imprinted or affixed to it are brought to the reader 10 and positioned such that the target bar code 34 is within the field of view FOV of the reader imaging system 12 for reading the target bar code 34. Typically, the imaging system 12 is always on or operational in the fixed position mode to image and decode any target bar code presented to the reader 10 within the field of view FOV.

The docking station 30 is plugged into an AC power source and provides regulated DC power to the circuitry 11 of the reader 10. Thus, when the reader 10 is in the docking station 30 power is available to keep the imaging system 12 on continuously. In the fixed position mode, the imaging system 12 produces a continuous, sequential series of image frames 54 of the field of view.

The bar code reader 10 includes an illumination system 36 to illuminate the target bar code 34. In one embodiment, the illumination system 36 typically includes one or more illumination LEDs which are energized to direct light in an illumination pattern generally corresponding to the imaging system field of view FOV.

An aiming system (not shown) may optionally be used to generate a visible aiming pattern comprising a single dot of illumination, a plurality of dots and/or lines of illumination or overlapping groups of dots/lines of illumination. If used, the aiming system may he intermittently energized in a flash mode such that at least some of the captured image frames 54a-54f do not include an image of the aiming pattern. The image of the aiming pattern in an image frame may distort the imaged bar code and complicate the decoding of the imaged bar code.

The imaging system 12 comprises an imaging camera assembly 20 and associated imaging circuitry 22. The imaging camera 20 includes a housing 24 supporting an imaging lens system 26 and a 2D sensor or pixel array 28. The sensor array 28 is enabled during an exposure period to capture an image of the field of view FOV of the imaging system 12.

The camera housing 24 is positioned within an interior region 17 of the scanning head 16b. The housing 24 is in proximity to a transparent window 50 defining a portion of a front wall 16h of the housing scanning head 16b. Reflected light from the target bar code 34 passes through the transparent window 50, is received by the imaging lens system 26 and focused onto the imaging system sensor array 28.

In an exemplary embodiment, the illumination assembly 36 is positioned behind the window 50. Illumination from the illumination LED 38 and an aiming pattern (if used) also pass through the window 50.

The imaging system 12 includes the sensor array 28 of the imaging camera assembly 20. The sensor array 28 comprises a charged coupled device (CCD), a complementary metal oxide semiconductor (CMOS), or other imaging pixel array, operating under the control of the imaging circuitry 22. In one exemplary embodiment, the sensor array 28 comprises a two dimensional (2D) mega pixel CMOS array with a typical size of the pixel array being on the order of 1280×1024 pixels. Each pixel is comprised of a photosensitive element or photosensor that receives light and stores a charge proportional to the intensity of the light received and then is periodically discharged to generate an electrical signal whose magnitude is representative of the charge on the photosensitive element during an exposure period.

In the hand-held mode of operation, (possibly aided by the aiming system), the user points the housing 16 at the target bar code 34 and, assuming the target bar code 34 is within the field of view FOV of the imaging assembly 12, each image frame 54a, 54b, 54c, . . . of the series of image frames 54 includes an image 34′ of the target bar code 34 (shown schematically in FIG. 4). The decoding system 14 selects an image frame from the series of image frames 54 and attempts to locate and decode a digitized version of the image bar code 34′.

The image frame selected for decoding by the decoding system 14 is typically an image frame captured when the aiming system 38 is turned off, otherwise, the aiming pattern 40 projected onto the target bar code 34 may distort the resulting imaged bar code 34′. In the fixed position mode of operation, the imaging system 12 is continuously generating a series of image frames 54. Since most of these captured frames 54 will not include an imaged bar code, the decoding system must analyze the series of image frames to find a subset of the series of image frames 54 (say 54a-54d in FIG. 5) that include the imaged bar code 34′. One of this image frame subset 54a-54d, one of the captured image frames 54d is selected for decoding.

Electrical signals are generated by reading out some or all of the pixels of the pixel array 28 after an exposure period generating an analog signal 56 (FIG. 4). In some sensors, particularly CMOS sensors, all pixels of the pixel array 28 are not exposed at the same time, thus, reading out of some pixels may coincide in time with an exposure period for some other pixels.

The analog image signal 56 represents a sequence of photosensor voltage values, the magnitude of each value representing an intensity of the reflected light received by a photosensor/pixel during an exposure period. The analog signal 46 is amplified by a gain factor, generating an amplified analog signal 58. The imaging circuitry 22 further includes an analog-to-digital (A/D) converter 60. The amplified analog signal 58 is digitized by the A/D converter 60 generating a digitized signal 62. The digitized signal 62 comprises a sequence of digital gray scale values 63 typically ranging from 0-255 (for an eight bit A/D converter, i.e., 2⁸=256), where a 0 gray scale value would represent an absence of any reflected light received by a pixel during an exposure or integration period (characterized as low pixel brightness) and a 255 gray scale value would represent a very intense level of reflected light received by a pixel during an exposure period (characterized as high pixel brightness).

The digitized gray scale values 63 of the digitized signal 62 are stored in a memory 64. The digital values 63 corresponding to a read out of the pixel array 28 constitute the image frame 54, which is representative of the image projected by the imaging lens system 26 onto the pixel array 28 during an exposure period. If the field of view FV of the focusing lens 26 includes the target bar code 34, then a digital gray scale value image 14′ of the target bar code 14 would be present in the image frame 54.

The decoding circuitry 14 then operates on the digitized gray scale values 63 of the image frame 54 and attempts to decode any decodable image within the image frame, e.g., the imaged target bar code 14′. If the decoding is successful, decoded data 66, representative of the data/information coded in the bar code 34 is then output via a data output port 67 and/or displayed to a user of the reader 10 via a display 68. Upon achieving a good “read” of the bar code 34, that is, the bar code 34 was successfully imaged and decoded, a speaker 70 and/or an indicator LED 72 is activated by the bar code reader circuitry 13 to indicate to the user that the target bar code 14 has successfully read, that is, the target bar code 14 has been successfully imaged and the imaged bar code 14′ has been successfully decoded.

### Imaging Lens System 26

The field of view FOV of the imaging assembly 12 is a function of a number of parameters including the size and configuration of the sensor array 28 and the optical characteristics of the imaging lens system 26. The imaging lens system advantageously provided for two different fields of views FV1, FV1 which comprise the imaging assembly field of view FOV and two different working ranges WR1, WR2 resulting from differing focal lengths FL1, FL2. In this way, the reader 10 has an enhanced ability and flexibility to reader target bar codes 34 at various distances from the imaging lens system 26 as well as target bar codes having differing densities and height/width dimensions. Further, this enhanced barcode imaging provided by the imaging lens system 26 does not require the increased cost and complexity associated with variable focus/zoom lens systems. A simpler, fixed lens system is utilized.

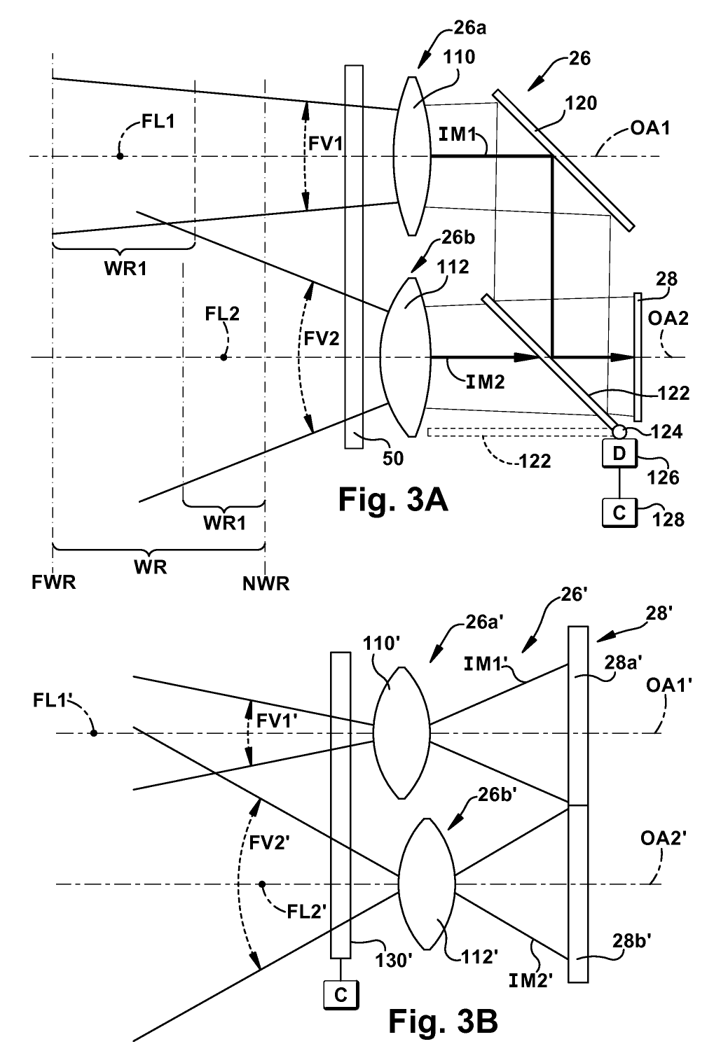

The imaging lens system 26 of the present invention utilizes a dual lens system, that is, the imaging lens system 26 comprises two imaging lens assemblies 26a, 26b, each of the lens assemblies 26a, 28b having its own different respective fields of view FV1, FV2 and its own different respective focal length FL1, FL2. The fields of view FV1, FV2 of the lens assemblies 26a, 26b are different, but do overlap. As the working ranges WR1, WR2 are determined in part by respective focal lengths FL1, FL2, the differing focal lengths FL1, PL2 result in different working ranges WR1, WR2. The working ranges WR1, WR2, while different do-overlap such that the overall working range WR of the reader 10 is continuous from the near working range NWR to the far working range FWR. As can be appreciated from the schematic representation of FIG. 3A, the focal length. FL1 of the first imaging lens assembly 26a is a greater length, than the focal length FL2 of the second imaging lens assembly 26b. This results in the first imaging lens assembly 26a having a relatively far focus (far working range WR1) and a relatively narrow field of view FV1 as compared to the relatively near focus (near working range WR2) and relatively wide field of view FV2 of the second imaging lens assembly 28b. While the schematic view shown in FIG. 3A is a top plan view of the imaging lens system 26 and, therefore, the horizontal components of the fields of view FV1, FV2 are seen in FIG. 3A, it should be recognized the fields of view FV1, FV2 have vertical components as well which are not shown.

The present invention contemplates at least two embodiments of the imaging lens system 26 and those of skill in the art will recognize that other embodiments are possible and within the scope of the present invention. A first exemplary embodiment of the imaging lens system 26 is shown in FIG. 3A, while a second exemplary embodiment of the imaging lens system 26′ is shown in FIG. 3B.

In FIG. 3A, the imaging lens system 26 includes dual imaging lens assemblies 26a, 26b which arc positioned in spaced apart, parallel, relationship within the camera housing 24 such that the are adjacent the transparent window 50 of the housing scanning head 16b. The illustrated imaging lens assemblies 26a, 26b are schematically shown to each include a single optical lens 110, 112, respectively, for simplicity. It should be understood, however, that the lens assemblies 26a, 26b would typically include a series of different lenses along with an aperture stop supported within a lens holder. The series of lenses and the aperture stop together defining the fields of view FV1, FV2 and the focal lengths FL1, FL2. Such a series of lenses and aperture which constitute a lens assembly suitable for an imaging-based bar code reader is described in detail in U.S. application Ser. No. 11/731,835, filed on Mar. 30, 2007 and entitled “Compact Imaging Lens Assembly for an Imaging-Based Bar Code Reader” and assigned to the assignee of the present invention. The '835 application is incorporated herein in its entirely by reference.

The imaging lens system 26 (in contrast to the FIG. 3B embodiment) focuses the image from the respective fields of view FV1, FV2 onto a single sensor array 28 and, more particularly, onto the same general region or area of the sensor array 28. The imaging lens system 26 includes a pair of fold mirrors 120, 122, the second fold mirror being pivotal about a pivot or hinge 124 by a drive 126 (shown schematically in FIG. 3A). The mirror 120 is at substantially a 45 degree angle with respect to the optical axis OA1 of the imaging lens assembly 26a, while in the position shown in solid line in FIG. 3A, the pivoting mirror 122 is at substantially a 45 degree angle with respect to the optical axis OA2 of the imaging lens assembly 26b.

A control 128 actuates the drive 126 to move the pivoting mirror 122 between a first position (shown in solid line in FIG. 3A) and a second position (shown in dashed line in FIG. 3A). The control 128 may be embodied as part of the microprocessor 11a or may be embodied in circuitry or software that is part of the imaging circuitry 22. When the pivoting mirror 122 is in the first position, the light focused by the first imaging lens assembly 26a is directed to the fold mirror 120 where it is reflected to a back side mirrored surface 122a of the pivoting fold mirror 122 and then reflected to intersect a light receiving surface of the sensor array 28. In the first position, the light focused by the second imaging lens assembly 26b is prevented from reaching the sensor array 28. When the pivoting mirror 122 is in the second position, the light from the second imaging lens assembly 26b is focused onto the light receiving surface of the sensor array 28, while the light focused by the first imaging lens assembly 26a is prevented from reaching the sensor array 28.

The first imaging lens assembly 26a focuses an image (schematically shown as IM1 in FIG. 3) of the field of view FV1 onto the sensor array 28, while the second imaging lens assembly 26b focuses an image (schematically shown as IM2 in FIG. 3A.) onto the sensor array 28. By controlling the drive 126, the control 128 selects the image IM1, IM2 and therefore the image 34′ of the target bar code 34 projected onto the sensor array 28. The control 128 works in conjunction with the other imaging circuitry 22 and the decoding system 14 to select the image IM1, IM2 that provides the best resolution and most decodable target bar code image 34′. Thus, during the course of a reading session, that is, a session for imaging and decoding the target bar code 34, the control 128 may pivot the pivoting fold mirror 122 once or a number of times, thereby, changing images between IM1 and IM2 until a satisfactory, decodable image 34′ of the target bar code 34 is achieved.

Since the optical path from the lens assemblies 26a, 26b to the array 28 is fixed, this means that the best in focus target plane is fixed for each lens assembly 26a, 26b as is the respective fields of view FV1, FV2. It is appreciated that although the best in focus target plane is fixed, the depth of field or wording range for a given lens assembly allows images to be captured from target bar codes not precisely coincident with the most in-focus target plane.

In an alternate or second embodiment shown schematically in FIG. 3B, the imaging lens system 26′ again has two imaging lens assemblies 26a′, 26b′. In this embodiment, the sensor array 28′ includes two sensor array areas 28a′, 28b′ which are positioned in perpendicular alignment with the respective optical axis OA1′, OA2′ of the imaging lens assemblies 26a′, 26b′. The sensor array areas 28a′, 28b′ may comprise two separate sensor arrays. Alternately, the areas 28a′, 28b′ may be spaced apart regions of a larger single array. In any event, a region or area of the sensor array 28′ where the image IM1′ generated by the first imaging lens assembly 26a′ is focused is spaced apart from a region or area of the sensor array 28′ where the image IM1′ generated by the second imaging lens assembly 26b′ is focused.

This embodiment eliminates the need for the two fold mirrors set forth in the first embodiment. As was the case in the first embodiment, the lens 112′ of the second lens assembly 26b′ has a short focal distance FL2′ and therefore a large or wide field of view FV2′ compared to the long focal distance FL1′ and narrow field of view FV1′ of the first lens assembly 26a′.

It may be desirable to have the images IM1′, IM2′ constantly and simultaneously generated during a bar code reading session. In this way, the control 128′ (as described in the first embodiment) in conjunction with the remaining imaging circuitry 22 and the decoding system 14 can determine which image IM1′, IM2′ should be selected for processing and decoding. In other circumstances, it maybe desirable to provide an optical switch 130′ operating under the control of the control 128′ to block out light from being received by one or the other of the imaging lens assemblies 26a′, 26b′ thereby eliminating a selected one of the images IM1′, IM2′. The optical switch 130′ may be implemented as a pair of mechanical stops in front of the lens assemblies 26a′, 26b′ which can be selectively moved into or out of the respective fields of view FV1′, FV2′ by the control 128′. Alternately, the optical switch 130′ can be implemented as a liquid crystal cell with selective light transmission under the control of the control 128′. This liquid crystal embodiment maybe integrated into the transparent housing window 50. Yet another alternative for the optical switch 130′ is a controlled polarizer element that is switched on and off by the control 128′.

Finally, it should be noted that while the imaging lens system of the present invention has been discussed with respect to a 2D sensor array, the concept of a dual focusing system is equally applicable to a one dimensional (1D) or linear sensor array which would be used to imaging 1D bar codes.

While a preferred embodiment of the invention has been described with a degree of particularity, it is the intent that the invention includes all modifications and alterations from the disclosed design falling within the spirit or scope of the appended claims.

We claim:

1. An imaging system for an imaging-based bar code reader for capturing an image of a target bar code, the imaging system comprising:
a sensor array including an array of photosensitive elements for converting light impinging on the array of photosensitive elements into electrical signals based on light intensity;
an imaging lens system for focusing light from a field of view onto the sensor array, the imaging lens system including a first lens assembly and a second lens assembly, the first lens assembly defining a first field of view and the second lens assembly defining a second field of view, the first and second fields of view being different; and
a control for selectively choosing between the first and second fields of view for imaging the target bar code.

2. The imaging system of claim 1 wherein the first lens assembly focuses light from the first field of view onto a first portion of the sensor array and the second lens assembly simultaneously focuses light from the second field of onto a second portion of the sensor, the first and second portions of the sensor array being different.

3. The imaging system of claim 2 wherein the sensor array comprises a first sensor array and a second sensor array, the first portion of the sensor array comprising the first sensor array and the second portion of the sensor array comprising the second sensor array.

4. The imaging system of claim 1 wherein the imaging lens system includes movable mirror coupled to the control for directing light from a selected one of the first and second lens assemblies onto the sensor array.

5. The imaging system of claim 1 wherein the control comprises imaging circuitry for evaluating images projected by the first and second lens assemblies onto the sensor array.

6. The imaging system of claim 1 additionally comprising an optical switch for blocking light from one of the first and second lens assemblies from reaching the sensor array.

7. The imaging system of claim 6 wherein the optical switch is positioned in front of the first lens assembly for selectively allowing light to pass through the first lens assembly.

8. The imaging system of claim 7 wherein the optical switch comprises a mechanical stop.

9. The imaging system of claim 7 wherein the optical switch is a polarizing filter.

10. The imaging system of claim 7 wherein the optical switch is a liquid crystal element.

11. A bar code reader for imaging and decoding a target bar code, the reader comprising:
a reader housing including a housing interior;
an illumination assembly supported by the housing for emitting light to illuminate the target bar code;
an imaging system within said housing interior for capturing an image of the target bar code including;
a sensor array including an array of photosensitive elements for convening light impinging on the array of photosensitive elements into electrical signals based on light intensity;
an imagine lens system for focusing light from the field of view onto the sensor array, the imaging lens system including a first lens assembly and a second lens assembly, the first lens assembly defining a first field of view and the second lens assembly defining a second field of view, the first and second fields of view being different; and
a control for selectively choosing between the first and second fields of view for imaging the target bar code; and
decoding circuitry for decoding an image of the target bar code.

12. The bar code reader of claim 11 wherein the first lens assembly focuses light from the first field of view onto a first portion of the sensor array and the second lens assembly simultaneously focuses light from the second field of onto a second portion of the sensor, the first and second portions of the sensor array being different.

13. The bar code reader of claim 12 wherein the sensor array comprises a first sensor array and a second sensor array, the first portion of the sensor array comprising the first sensor array and the second portion of the sensor array comprising the second sensor array.

14. The bar code reader of claim 11 wherein the imaging lens system includes movable mirror coupled to the control for directing light from a selected one of the first and second lens assemblies onto the sensor array.

15. The bar code reader of claim 11 wherein the control comprises imaging circuitry for evaluating images projected by the first and second lens assemblies onto the sensor array.

16. The bar code reader of claim 11 additionally comprising an optical switch for blocking light from one of the first and second lens assemblies from reaching the sensor array.

17. The bar code reader of claim 16 wherein the optical switch is positioned in front of the first lens assembly for selectively allowing light to pass through the first lens assembly.

18. The bar code reader of claim 16 wherein the optical switch comprises a mechanical stop.

19. The bar code reader of claim 17 wherein the optical switch is a polarizing filter.

20. The bar code reader of claim 17 wherein the optical switch is a liquid crystal element.

21. A method of imaging a target bar code, the steps of the method comprising:
providing an imaging system including: a sensor array including an array of photosensitive elements for converting light impinging on the array of photosensitive elements into electrical signals based on light intensity; an imaging lens system for focusing light from a field of view onto the sensor array, the imaging lens system including a first lens assembly and a second lens assembly, the first lens assembly defining a first field of view and the second lens assembly defining a second field of view, the first and second fields of view being different; and a control for selectively choosing between the first and second fields of view for imaging the target bar code
activating the imaging system and positioning the target bar code within at least one of the first and second fields of view; and
imaging the target bar code utilizing a selected one of the first and second fields of view.

22. An imaging system for an imaging-based bar code reader for capturing an image of a target bar code, the imaging system comprising;
a sensor array means for converting light impinging on the array of photosensitive elements into electrical signals based on light intensity;
an imaging lens system means for focusing light from a field of view onto the sensor array, the imaging lens system means including a first lens assembly and a second lens assembly, the first lens assembly defining a first field of view and the second lens assembly defining a second field of view, the first and second fields of view being different; and
a control means for selectively choosing between the first and second fields of view for imaging the target bar code.
